(19) United States
(12) Patent Application Publication
(10) Pub. No.: US 2010/0029854 A1
(43) Pub. Date: Feb. 4, 2010

(54) THERMOPLASTIC POLYMER-BASED SOLID DISPERSIONS SUITABLE AS FILTER AIDS

(76) Inventors: Klemens Mathauer, Taipei (TW); Marianna Pierobon, Ludwigshafen (DE); Simone Schillo, Ludwigshafen (DE); Ralf Widmaier, Ludwigshafen (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/515,109

(22) PCT Filed: Dec. 3, 2007
(86) PCT No.: PCT/EP07/63157

§ 371 Date: May 15, 2009

(30) Foreign Application Priority Data
Dec. 4, 2006 (EP) 06125344.9

(51) Int. Cl. C08L 39/06

(52) U.S. Cl. 525/203

(57) ABSTRACT

Solid dispersions of thermoplastic polymers and a crosslinked water-insoluble polymer, which solid dispersions are suitable as filter aids, wherein the solid dispersions comprise 20 to 95% by weight of at least one thermoplastic polymer (component A) and 5 to 80% by weight of at least one crosslinked water-insoluble polymer selected from the group consisting of homopolymers of N-vinylformamide, N-vinylcaprolactam, N-vinylpiperidone, N-vinylpyridines, N-vinylimidazoles, styrene monomers, acrylates and methacrylates and also copolymers of basic N-vinyl compounds, styrene monomers, acrylates and methacrylates (component B).

The present invention relates to thermoplastic polymer-based solid dispersions and to crosslinked water-insoluble polymers which are obtained by processing the components in an extruder, and also to the use of such agents as filter aids.

Separation of solid-liquid mixtures of substances by filtration is an important process step in many industrial production processes. The expression filter aid is taken to mean a number of products which are used in filtration in bulk, pulverulent, granulated or fibrous form.

Filter aids can be applied to the filter before the start of filtration as a filter aid layer (precoat filter) in order to achieve a looser cake structure, or can be added continuously to the pulp to be filtered.

The expression filtration is taken to mean passing a suspension (pulp) through a porous filter medium, which suspension comprises a discontinuous phase (disperse substances) and a continuous phase (dispersion medium). In this process solid particles are deposited on the filter medium and the filtered liquid (filtrate) leaves the filter medium in clear form. The external force which acts to overcome the resistance to flow in this case is an applied pressure difference.

In the filtration process, mechanisms of solid removal different in principle may be observed. These are surface or cake filtration, layer filtration and also sieve filtration. A combination of at least two processes is involved.

In the case of surface or cake filtration, what are termed precoat filters are used in various embodiments for drinks filtration.

In all precoat systems, the solids present in the liquid to be filtered, and also the intentionally added solids (filter aids) are retained by a filter medium, a filter cake building up. In the course of filtration, flow must pass through this filter cake, just as with the filter medium. Such a filtration is also termed precoat filtration.

The liquids to be filtered according to the invention are taken to mean, inter alia, drinks, in particular fruit juices or fermented drinks such as wine or beer. In particular, the filter aid obtained according to the process of the invention is used for filtration of wine. The filter aids, however, can also be used, for example, for treating tea products, sparkling wines or generally for adsorption of unwanted components from foods and drinks.

In addition, according to the invention, liquids to be filtered are also taken to mean generally wastewaters such as wastewaters, for example which are polluted with dyes or other chemicals. In particular, these are taken to mean wastewaters which are polluted with radioactive material.

According to the invention, in particular polyphenols and metal ions or semimetal ions are intended to be depleted in the liquid to be filtered. In addition, odor compounds or flavor compounds are also intended to be depleted, for example sulfurous compounds from wine or sparkling drinks.

EP 351 363 describes highly crosslinked polyvinylpyrrolidones as stabilizers and filter aids.

WO 96/35497 describes filter aids made of polyamides and crosslinked polyvinyl-pyrrolidone homopolymers.

WO 01/68727 discloses vinyllactam popcorn polymers and use thereof as drinks clarifiers.

DE-A 199 20 944 and DE-A 101 60 140 describe styrene-containing popcorn polymers and use thereof as filter aids.

DE-A 102 57 095 describes styrene 4-sulfonate-comprising popcorn polymers and use thereof for filtering liquids.

DE-A 101 08 386 discloses popcorn polymers based on (meth)acrylates and use thereof as filter aids.

DE-A 40 00 978 discloses a process for removing heavy metals from wine using crosslinked polymers of basic N-vinyl heterocycles.

EP-A 175 335 discloses crosslinked copolymers of N-vinylpyrrolidone and comonomers such as (meth)acrylates, N-vinyl carboxamides, N-vinylimidazole or vinyl esters and use thereof as adsorbents.

EP-A 177 812 discloses popcorn polymers based on monoethylenically unsaturated carboxylic acids or esters or amide derivatives thereof.

U.S. Pat. No. 5,599,898 discloses popcorn polymers of N-vinyl carboxamides and use thereof as ion exchange resins and as adsorbents for metal ions.

WO 02/32544 discloses filter aids based on polystyrene. Production can proceed by compounding the polystyrene in the presence of a further component in the extruder. As further component, in addition to a multiplicity of inorganic compounds such as silicates, carbonates, oxides and the like, use can also be made of polymers such as, for example, crosslinked polyvinylpyrrolidone.

WO 2005/113738 discloses blends of thermoplastic polymers and crosslinked polyvinylpyrrolidone homopolymers and use thereof as filter aids.

WO 03/084639 describes blends of thermoplastic polymers and crosslinked polyvinyl-lactam or polyvinylamine homopolymers and also use thereof as filter aids.

However, the previously known filter aids still leave room for improvements with respect to application properties, in particular with respect to selectivity in the absorption of heavy metal ions and/or the absorption of polyphenols/catechins.

The object of the present invention was to find filter aids having improved properties.

Accordingly, solid dispersions of thermoplastic polymers and a crosslinked water-insoluble polymer, which solid dispersions are suitable as filter aids, have been found, wherein the solid dispersions comprise 20 to 95% by weight of at least one thermoplastic polymer (component A) and 5 to 80% by weight of a crosslinked water-insoluble polymer selected from the group consisting of homopolymers of N-vinylformamide, N-vinylcaprolactam, N-vinylpiperidone, N-vinylpyridines, N-vinylimidazoles, styrene monomers, acrylates and methacrylates and also copolymers of basic N-vinyl compounds, styrene monomers, acrylates and methacrylates (component B).

As solid dispersion, use is made according to the invention of mixtures of the thermoplastic polymer component and the non-thermoplastic water-insoluble crosslinked polymer component which do not separate. In this case the quantitatively lesser component is present dispersed in the quantitatively greater component. A characteristic of the solid dispersion, is, in addition, is that the solid dispersion cannot be fractionated into the individual components using mechanical means.

As thermoplastic component A, the following polymers come into consideration: styrene homopolymers and copolymers, polyamides, poly(vinyl chloride), polyolefins such as polyethylene, polypropylene, copolymers of ethylene/propylene, polybutene, polymethylpentene or polyoxymethylene, polymethacrylates, polyesters, polyacetates, polycarbonates or polyurethanes. Use can also be made of mixtures of thermoplastic polymers.

Preferred components A are polystyrenes, polyamides, polyethylene and/or polypropylene.

According to the invention, the solid dispersions, in addition to the thermoplastic polymer component, comprise as second component B water-insoluble, crosslinked polymers which do not form a gel on water absorption which are also termed in the literature popcorn polymers (cf. J. W. Breitenbach, Chimia, Vol. 21, pp. 449-488, 1976). Such polymers exhibit a porous structure and are rich in cavities. The polymers, as stated, are also not gel-forming on water uptake. The swelling volume of such polymers in water at 20° C. is customarily in the range 2 to 10 l/kg, preferably 4 to 8 l/kg.

Production of such popcorn polymers is known per se. Whether a polymerization leads to popcorn polymers instead of vitreous polymers is essentially influenced by the process procedure. Suitable processes for producing popcorn polymers that are used in the context of the present invention are disclosed by publications listed hereinafter, the disclosure of which with respect to production and composition of popcorn polymers is hereby explicitly incorporated herein by reference.

Compounds suitable as component B are homopolymers of N-vinylformamide, N-vinylcaprolactam, N-vinylpiperidone, N-vinylpyridines and N-vinylimidazoles such as N-vinylimidazole or 2-methyl or 4-methyl derivatives thereof.

In addition, homopolymers and copolymers of styrene-comprising polymers are suitable: these are taken to mean according to the invention crosslinked homopolymers and copolymers of 3-styrene or 4-styrene sulfonates and the Na salts of such styrene sulfonates. In addition, also crosslinked polymers which comprise at least 50% by weight styrene and a monounsaturated styrene derivative. Likewise, polymers of amino-comprising styrene monomers are suitable. Such polymers and production thereof are described, for example, in DE 199 20 944 and DE 102 57 095, which are hereby incorporated herein by reference.

In addition, as component B, crosslinked homopolymers and copolymers based on α,β-unsaturated carboxylic acids and derivatives of such carboxylic acids come into consideration, as described in DE 101 08 386, which are hereby incorporated herein by reference. Preferably, the polymers, as carboxylic acids, comprise acrylic acid or methacrylic acid, as derivatives acrylamide, methacrylamide, or C1-C18 alkyl esters, in particular the methyl, ethyl, propyl, isopropyl, n-butyl, isobutyl, tert-butyl, hydroxyethyl, hydroxypropyl or hydroxybutyl esters of acrylic acid or methacrylic acid. In addition, the polymers, as further comonomers, can comprise basic N-vinylamides, styrenes or styrene derivatives.

In addition compounds which are suitable are copolymers of basic N-vinyl compounds such as N-vinylformamide, N-vinylpyrrolidone, N-vinylpiperidone, N-vinylpyridines and N-vinylimidazoles such as N-vinylimidazole or 2-methyl or 4-methyl derivatives thereof which, as comonomers, can comprise the abovementioned styrene or acrylate or methacrylate monomers. In addition compounds which are suitable are copolymers of mixtures of these basic N-vinyl monomers, preferably copolymers of N-vinyl-pyrrolidone/N-vinylformamide or vinylpyrrolidone/N-vinylimidazole.

With respect to suitable polymers and production thereof, in addition, EP-A 177812, DE-A 2437640, DE-A 2437629 and EP-A 88 964 are explicitly incorporated herein by reference.

Preferred copolymers used as components B are N-vinyllactam copolymers or acrylates.

Very particularly preferred components B are copolymers of N-vinylimidazole/N-vinyl-pyrrolidone in the weight ratio 90/10.

The popcorn polymers used as components B generally have mean particle sizes of 15 μm to 1500 μm.

The quantitative ratios in this case are selected in such a manner that the filter aid comprises 20 to 95% by weight, preferably 50 to 85% by weight, particularly preferably 60 to 75% by weight, of a thermoplastic polymer, and 5 to 80% by weight, preferably 15 to 50% by weight, particularly preferably 25 to 40% by weight, of a crosslinked water-insoluble polymer.

The filter aids of the invention are preferably obtained by extrusion processes. In these processes the components are processed together in an extruder, the processing conditions being selected in such a manner that the thermoplastic polymer melts in whole or in part. The crosslinked polymer component does not melt under the processing conditions. It can also be advisable to carry out the extrusion in the presence of water. As a result of the joint processing in the extruder, an intimate mixing of the components occurs, the components after processing no longer being able to be separated from one another by methods such as sieving.

Suitable for the process of the invention are in principle the customary extruder types known to those skilled in the art. These customarily comprise a housing, a drive unit and also a plastifying unit of one or more rotating axles provided with transport or kneading elements (screws).

Along the screws, there extend in the transport direction a plurality of sections which in the process according to the invention comprise an intake zone, a mixing zone and an injection zone. In addition, degassing zones can also be provided, wherein the degassing can proceed at atmospheric pressure and/or under vacuum. The vacuum degassing can proceed, for example, using a feed screw and a steam jet pump.

Each of these sections can in turn comprise one or more cylinders (sections) as smallest independent unit.

Production of the polymer blend can proceed in a single-screw extruder, a twin-screw extruder, or in multiple-screw extruders, but preferably in a twin-screw extruder. A plurality of screws can be designed to be corotating or counterrotating, meshing or not meshing. The extruder is preferably designed to be corotating and tightly meshing. The individual cylinders are to be heatable. In addition, the cylinders can also be designed for cooling, for example for cooling with water.

The screws can be constructed from all elements customary in extrusion. They can, in addition, comprise customary transport elements also kneading disks or backflow elements. The screw configuration which is suitable in an individual case can be determined by those skilled in the art by simple measurements. The ratio of screw length to screw diameter (LD ratio) can be 25:1 to 50:1, preferably 30:1 to 40:1. The extruder used according to the invention is essentially composed of the following sections:

In a first section, the thermoplastic polymer is introduced into the extruder and melted. The screw geometry in this section corresponds to the customary conditions for transporting and melting thermoplastic polymers. The cylinder provided with a feed device is followed by one to two cylinders in which the thermoplastic polymer is melted. In this region, the screws, in addition to transport elements, can also be fitted with kneading disks.

In a second section which is designed as a mixing zone, the crosslinked water-insoluble polymer is transported to the molten thermoplastic polymer. The molten thermoplastic polymer, before feed, is preferably deaerated or degassed. The degassing/dearation proceeds at pressures of 0.005 to 0.1 MPa, preferably at atmospheric pressure. The components are then mixed intimately, so that the water-insoluble polymer which is firmly crosslinked under the processing conditions is homogeneously dispersed in the molten thermoplastic polymer. This section likewise comprises conventional transport elements. To transport the mixture, it can be advisable additionally to incorporate kneading disks. In addition, it can be advisable for additional improvement of mixing, to incorporate backflow elements also. For this section, customarily, one to three cylinders are provided.

Between this mixing zone and the third section, baffle elements are mounted which are intended to avoid steam returning into the feed device for the crosslinked polymer and blocking it.

In the third section, if desired, water can be transported to the mixture of the polymeric components. Addition of water can proceed via customary filling devices, for example via funnel-shaped filling devices or using metering pumps. Subsequently, the water-comprising mass is transported further in the direction of the discharge orifice with mixing of water and melt. This section, depending on the amount of the mass to be processed, can be made up of one to three cylinders.

Between the third section in which, if desired, water is fed, and the discharge orifice, a degassing zone having one or more cylinders can also be provided, the degassing being able to proceed at atmospheric pressure and/or vacuum. Preferably, degassing proceeds at pressures of 0.005 to 0.1 MPa. Between the degassing zone and discharge orifice, further cylinders can be provided.

Subsequently, the still plastic mass is discharged from the extruder. Discharge can proceed via customary nozzle plates, perforated plates or other suitable devices.

The filling zone for the thermoplastic polymer is customarily not heated. All remaining zones and also transition pieces between extruder and nozzle plate and also the nozzle plate itself are heated in order to ensure plasticity of the mass.

Customarily, the jacket temperature of the extruder barrels, the temperature of the transition piece and the nozzle plate is 180 to 220° C. At all events, the jacket temperature must be selected in such a manner that the mass temperature is above the melting point of the thermoplastic polymer, but below the decomposition temperature of the crosslinked polymer.

The still plastic mixture is preferably extruded through a nozzle and comminuted. Suitable techniques for comminution are in principle all techniques customarily known for this such as hot-cut or cold-cut pelletizing.

The extrudate is cut, for example, using a rotating blade or using an air jet.

In addition, the extrudate can be granulated by water ring granulation.

Subsequently, the extrudate can if appropriate be milled. Milling can proceed in one or more steps, preferably in two steps, such that the desired particle size is set. Mean particle sizes of 20 to 250 μm can be set. Milling can proceed after precomminution (first milling step) in any commercially conventional rotator mill, preferably a counter-rotating pin mill, with cooling of the product using liquid nitrogen or another commercially conventional cold source, for example dry ice, to a temperature of −50° C. to +5° C., in a second milling step in any commercially conventional opposed jet mill. A suitable process for the second milling is preferably cold milling. In this case a cold inert gas is fed to the mass to be milled. As milling gas use can be made of, for example, nitrogen or argon. The milling gas is preferably cooled to temperatures of −50 to +5° C.

For use as filter aid, use can be made of both milled extrudates having a uniform mean particle size, and mixtures of milling fractions having different mean particle sizes. For instance, a mixture of milled extrudate of the first milling step and milled extrudate of the second milling step, for example, can be used. The quantitative ratios of such mixtures are optional and depend customarily on the type of the product to be filtered. For instance, use can be made of, for example, mixtures of a milling product of the first milling step with milling product of the second milling step with quantitative ratios of 5:95 to 95:5, 20:80 to 80:20, 30:70 to 70:30, 40:60 to 60:40: or 50:50. Equally, however, use can also be made of milling products of the second milling step having mean particle sizes of 20 to 40 pm alone. The milling product of the first milling step having mean particle sizes of 45 to 100 pm can also be used alone.

The extrudates of the invention, when used as filter aid, have improved application properties. Surprisingly, synergistic effects may sometimes be observed, especially in metal ion absorption.

### EXAMPLES

The experiments carried out in the examples hereinafter were carried out using a corotating tightly meshing ZSK40 twin-screw extruder from Wemer & Pfleiderer which was provided with a perforated plate at the extruder exit.

### Extruder Structure:

9 sections (zones 0 to 8), heated transition flange (zone 9), nozzle plate (zone 10). Between zone 5 and zone 6, the screws were fitted with a baffle element. The L/D ratio was 37.

The temperature profile for all experiments was selected as follows, with the barrel temperature being reported in each case:

zone 0: RT; zone 2: 200° C., zones 3-5: 180° C.; zone 6: 185° C.; zones 7-9: 190° C.;

nozzle plate: 210° C.

The speed of rotation of the screw was 200 rpm.

The exiting extrudate was shaped by strand pelletizing.

### Feed Materials

Components A

Polystyrene:

PS 185 K; density: 1.050 g/cm³; Vicat softening temperature: (50° C./h 50N) 101° C.

Lupolen® PE 2420:

Polyethylene; density 0.924 g/cm³; Vicat temp (B50 (50° C./h 50 N)): 92.0° C.; Melt temperature: 111° C.

Moplen®348T: random copolymer of ethylene/propylene; density: 0.905 g/cm3; Vicat temp. (B50 (50° C./h 50 N)): 92.0° C.

### Components B

Popcorn—Polymer 1: copolymer of vinylformamide/vinylpyrrolidone 90/10 (% by weight) unhydrolyzed, crosslinked with 2.2% by weight (based on monomers) divinyl-propyleneurea

Popcorn—Polymer 2: copolymer of vinylformamide/vinylpyrrolidone 90/10 (% by weight), hydrolyzed, crosslinked with 2.2% by weight (based on monomers) divinyl-propyleneurea

Popcorn—Polymer 3: copolymer of vinylimidazole/vinylpyrrolidone 90/10 (% by weight), crosslinked with 2.9% by weight (based on monomers) divinylethyleneurea

### Abbreviations:

NVP: N-vinylpyrrolidone

The quantities in the table below, unless otherwise stated, relate to % by weight.)

| Example | | | | | |
|---|---|---|---|---|---|
| No. | PS 158K | Popcorn 3 | Popcorn 1 | Popcorn 2 | Water*) |
| 1 | 70 | — | 30 | — | — |
| 2 | 70 | — | 30 | — | 0.7 |
| 3 | 70 | — | — | 30 | — |
| 4 | 70 | — | — | 30 | 0.7 |
| 5 | 70 | 30 | — | — | — |
| 6 | 70 | 30 | — | — | 0.7 |

| Example | Lupolen ® | Moplen ® | Popcorn - | Popcorn - |
|---|---|---|---|---|
| No. | 2420K | RP348T | Polymer 3 | Polymer 2 |
| 7 | 70 | — | 30 | — |
| 8 | — | 70 | 30 | — |
| 9 | — | 70 | — | 30 |
| 10 | 70 | — | — | 30 |

*)quantities based on the sum of the amounts of components A and B

### Milling

The extrudates, in each case, before milling were made brittle in liquid nitrogen and then comminuted using a pin mill. The figures in the table below relate to % by weight.

| Extrudate according to | | | |
|---|---|---|---|
| Example No. | <63 μm | 63 μm < x < 160 μm | >160 μm |
| 1 | 6.0 | 45.3 | 48.7 |
| 2 | 9.4 | 45.3 | 45.3 |
| 3 | 18.0 | 41.3 | 40.7 |
| 4 | 15.3 | 36.7 | 48.0 |
| 5 | 2.7 | 41.3 | 56.0 |
| 6 | 4.0 | 46.0 | 50.0 |
| 7 | 12.6 | 32.4 | 55.0 |
| 8 | 22.0 | 38.0 | 40.0 |
| 9 | 23.0 | 42.0 | 35.0 |
| 10 | 12.0 | 32.0 | 56.0 |

### Use Examples

### Methods

### Measurement of Metal Content

The samples were treated with concentrated mineral acids and the concentration of the metals in the resultant clear solutions was determined using ICP-OES (inductively coupled plasma—optical atomic emission spectrometry).

### Measurement of the Metal Content in Solutions:

The samples were diluted with dilute hydrochloric acid before measurement.

Determination of metal absorption:

Metal solutions A1 and A3: solutions comprising 1 g of metal/l were prepared:

Solution A1: Fe (2+): 3.2 g FeSO₄ in 1 l of demineralized water

Solution A2: Fe (3+): 4.85 g FeCl₃ in 1 l of demineralized water

Solution A3: Cu (2+): 2.51 g CUSO₄ in 1 l of demineralized water

Metal solution B: the solution contained 10 mg/l of Cu (2+) and 20 mg/l of Fe (2+) 0.128 g of FeSO₄ (85%) and 0.050 g of CuSO₄ in 2 l of demineralized water

1000 ml of metal solution B g were in each case stirred with the extrudate for 16 h and filtered off. The metals were analyzed in the resultant solutions.

(The results of the tables below are to be taken to mean mg of metal per liter of solution)

| | Fe (2+) | Cu (2+) |
|---|---|---|
| | content | content |
| | [mg/L] | [mg/L] |
| Before treatment | 20 | 10 |
| After treatment with extrudate 5 | 5.8 | 3.6 |
| After treatment with extrudate 6 | 6.5 | 4.2 |
| After treatment with extrudate 7 | 6.1 | 2.5 |
| After treatment with extrudate 8 | 5.2 | 1.8 |

### Filtration Properties:

10 g of the respective extrudate were each stirred with 500 ml of the respective metal solution (A1-A3) for the stated contact time, filtered, washed with 50 ml of demineralized water and dried in a drying cabinet at 50° C. in vacuum. (The results of the tables below are reported as g of metal per 100 g of extrudate and also, for comparison purposes, converted to the content of popcorn polymer in the extrudate)

Contact time: 2 hours

| | Fe (2+) content | Fe (3+) content | Cu (2+) content |
|---|---|---|---|
| | [g/100 g of | [g/100 g of | [g/100 g of |
| | extract.] | extract] | extract] |
| | Solution A1 | Solution A2 | Solution A3 |
| Extrudate 1 | 0.26 | 0.11 | 0.34 |
| Extrudate 3 | 0.15 | 0.03 | 0.19 |
| Extrudate 5 | 1.3 | 0.26 | 2 |
| Extrudate 6 | | | 2.3 |
| Extrudate 7 | 1.6 | | 2.5 |
| Extrudate 8 | 1.3 | | 2.5 |
| Extrudate 9 | 0.19 | | 0.17 |
| Extrudate 10 | 0.19 | | |
| | Fe (2+) content | Fe (3+) content | Cu (2+) content |
| | [g/100 g of | [g/100 g of | [g/100 g of |
| | popcorn] | popcorn] | popcorn] |
| Extrudate 1 | 0.87 | 0.37 | 1.13 |
| Extrudate 3 | 0.5 | 0.1 | 0.63 |
| Extrudate 5 | 4.3 | 0.87 | 6.7 |
| Extrudate 6 | | | 7.7 |
| Extrudate 7 | 5.3 | | 8.3 |
| Extrudate 8 | 4.3 | | 8.3 |
| Extrudate 9 | 0.63 | | 0.57 |
| Extrudate 10 | 0.63 | | |
| NVP Popcorn | | | 0.011 |
| homopolymer | | | |
| (comparative example) | | | |
| Popcorn - Polymer 3 | 3 | | 3.5 |
| (comparative example) | | | |

33 g of the extrudate were each stirred with 500 ml of the respective metal solution (A1-A3) for the specified time, filtered, washed with 50 ml of demineralized water and dried in a drying cabinet at 50° C. in vacuum.

Contact time: 2 hours

| | Fe (2+) content | Cu (2+) content |
|---|---|---|
| | in the compound after | in the compound after |
| | contact with solution A1 | contact with solution A3 |
| | [g/100 g] | [g/100 g] |
| Extrudate 5 | 0.9 | 1 |

### Polyphenol Adsorption

A polyphenol-containing stock solution was prepared from chlorogenic acid, rutin, scopoletin. 1 g of the milled extrudate powder was stirred with 200 ml of polyphenol solution for 5 min at room temperature and filtered.

The polyphenol concentration in the resultant solutions was determined by means of HPLC.

| | Chlorogenic | Rutin | Scopoletin |
|---|---|---|---|
| | acid [mg/L] | [mg/L] | [mg/L] |
| Extrudate 1 | 533 | 151 | 8 |
| Extrudate 5 | 466 | 150 | 8 |
| Stock solution | 661 | 161 | 8 |

| | Catechin | Swelling |
|---|---|---|
| | absorption | volume |
| Powder | [% by weight] | [l/kg] |
| Extrudate 1 | 7.48 | 3.4 |
| Extrudate 2 | 9.52 | 3.3 |
| Extrudate 3 | 4.42 | 3.1 |
| Extrudate 4 | 2.78 | 3.1 |
| Extrudate 5 | 8.98 | 3.1 |
| Extrudate 6 | 7.80 | 3.2 |

1. A solid dispersion of thermoplastic polymers and a crosslinked water-insoluble polymer, which solid dispersion is suitable as filter aid, wherein the solid dispersion comprises 20 to 95% by weight of at least one thermoplastic polymer (component A) and 5 to 80% by weight of at least one crosslinked water-insoluble polymer selected from the group consisting of homopolymers of N-vinylformamide, N-vinylcaprolactam, N-vinylpiperidone, N-vinylpyridines, N-vinylimidazoles, styrene monomers, acrylates and methacrylates and also copolymers of basic N-vinyl compounds, styrene monomers, acrylates and methacrylates (component B).

2. The solid dispersion according to claim 1, comprising as component A thermoplastic polymers selected from the group consisting of styrene homopolymers and copolymers, polyamides, poly(vinyl chloride), polyolefins, polyoxymethylene, polymethacrylates, polyesters, polyacetates, polycarbonates or polyurethanes.

3. The solid dispersion according to claim 1, comprising as polyolefin polyethylene, polypropylene, polybutene or polymethylpentene.

4. The solid dispersion according to claim 1, comprising as component A polyamides.

5. The solid dispersion according to claim 1, comprising as component A styrene homopolymers and copolymers.

6. The solid dispersion according to claim 1, comprising as component B homopolymers and copolymers of styrene monomers.

7. The solid dispersion according to claim 1, comprising as component B homopolymers and copolymers of styrene sulfonates.

8. The solid dispersion according to claim 1, comprising as component B homopolymers of acrylates or methacrylates.

9. The solid dispersion according to claim 1, comprising as component B homopolymers of N-vinylformamide.

10. The solid dispersion according to claim 1, comprising as component B copolymers of basic N-vinyllactams.

11. The solid dispersion according to claim 10, comprising as component B copolymers of N-vinylformamide, N-vinylpyrrolidone, N-vinylpiperidone, N-vinylpyridines and N-vinylimidazoles such as N-vinylimidazole or 2-methyl or 4-methyl derivatives thereof.

12. The solid dispersion according to claim 10, comprising as component B copolymers of N-vinylpyrrolidone and N-vinylimidazole.

13. The solid dispersion according to claim 10, comprising as component B copolymers of N-vinylpyrrolidone and N-vinylformamide.

14. The solid dispersion according to claim 1, comprising 50 to 85% by weight component A and 15 to 50% by weight component B.

15. The solid dispersion according to claim 1, comprising 60 to 75% by weight component A and 25 to 40% by weight component B.

16. The solid dispersion according to claim 1, obtained by joint processing of components A and B in an extruder, wherein, in the processing, component B is present in solid form and component A in the form of a melt.

17. (canceled)

18. The solid dispersion according to claim 2, comprising as polyolefin polyethylene, polypropylene, polybutene or polymethylpentene.

19. The solid dispersion according to claim 2, comprising as component A polyamides.

20. The solid dispersion according to claim 2, comprising as component A styrene homopolymers and copolymers.

21. The solid dispersion according to claim 2, comprising as component B homopolymers and copolymers of styrene monomers.
